(19) United States
(12) Patent Application Publication
(10) Pub. No.: US 2003/0030041 A1
(43) Pub. Date: Feb. 13, 2003

(54) Composition for forming infrared transmitting layer, infrared reflector, and processed article

(76) Inventors: Yasuhiro Genjima, Tokyo (JP); Haruhiko Mochizuki, Tokyo (JP); Taketoshi Matsuura, Tokyo (JP)

Correspondence Address: Charles R Hoffmann, Hoffman & Baron, 6900 Jericho Turnpike, Syosset, NY, 11791, US

(21) Appl. No.: 10/110,627

(22) PCT Filed: Mar. 23, 2001
(86) PCT No.: PCT/JP01/02317

(30) Foreign Application Priority Data
Aug. 15, 2000 (JP) 2000-246456

(51) Int. Cl. G02B 5/22

(52) U.S. Cl. 252/587

(57) ABSTRACT

The infrared reflector of the present invention has an infrared-reflecting layer and an infrared-permeable layer which is formed on the infrared-reflecting layer. The infrared-reflecting layer has a reflectance of 60% or more and a permeability of 25% or less with respect to infrared rays having a wavelength within a range of 800 to 1600 nanometers. The infrared-permeable layer has a reflectance of less than 60% and an absorbance of 50% or less with respect to infrared rays having a wavelength within a range of 800 to 1600 nanometers. The infrared-permeable layer contains resin components and pigments, and the amount of carbon black contained in the infrared-permeable layer is 0.1 wt % or less. This infrared reflector can provide various coloration that includes dark colors while maintaining the high infrared reflectivity on the whole.

### BACKGROUND OF THE INVENTION

1. Field of the Invention

The present invention relates to an infrared reflector which reflects infrared rays contained in sunlight and the like, as well as to a composition for forming an infrared-permeable layer which may be used in the manufacture of the infrared reflector, and a treated product using the same.

2. Background Art

Common paints contain carbon black as a portion of the pigment thereof, and the degree of brightness is adjusted by the amount of this carbon black which is contained. However, when common paints which contain carbon black in this way are employed in the painting of structures which are installed outdoors, the temperature of the structure rises as a result of sunshine, and the possibility has come to be pointed out that this leads to irregularities in the operation of precision mechanical equipment.

Here, recently, paints having a strong effect of reflecting infrared rays have also been proposed. Conventional infrared-reflecting paints are paints to which a metallic oxide system pigment having a high reflectance of infrared rays, such as titanium oxide, chromium oxide, cobalt oxide, barium oxide, and the like, has been added, and by applying such paints to the target object and forming a paint coating film having a monolayer structure, infrared rays were reflected.

When the color of such infrared-reflecting paints was bright, it was possible to increase the amount of metallic oxide system pigment contained, and it was thus possible to increase the reflectance of the infrared rays and to suppress the increase in temperature resulting from the infrared rays; however, where the color of the paint was dark, it was necessary to reduce the proportion of the metallic oxide system pigment which represented the bright color, and reflectance decreased by this amount, and there was an increase in the rise in temperature resulting from infrared rays. Accordingly, there were problems in that the range of colors which could be produced was narrow, and in particular, there was a limit to the brightness of the color, and in usages requiring design characteristics, these are serious defects.

### SUMMARY OF THE INVENTION

An object of the present invention is to solve the above described problem, and to increase infrared-reflecting characteristics. In concretely, it is an object of the present invention to provide an infrared reflector which has superior infrared-reflecting characteristics, has a wide range of possible colors, from colors having a high degree of brightness to colors having a low degree of brightness, and which permits a high degree of design freedom, as well as to provide a composition for forming an infrared-permeable layer which may be used in the manufacture of the infrared reflector, and a processed material for the same.

The composition for the infrared-permeable layer of the present invention includes a resin component and pigment having an absorbance of 50% or less with respect to infrared rays having a wavelength within a range of 800 to 1600 nanometers.

The pigment preferably includes one or two or more selected from a group containing iron oxide pigment, titanium oxide pigment, composite oxide system pigment, titanium oxide-coated mica pigment, iron oxide-coated mica pigment, scaly aluminum pigment, zinc oxide pigment, metallic phthalocyanine pigment, non-metallic phthalocyanine pigment, chlorinated phthalocyanine pigment, chlorinated-brominated phthalocyanine pigment, brominated phthalocyanine pigment, anthraquinone system pigment, quinacridone system pigment, diketo-pyrrolipyrrole system pigment, perylene system pigment, monoazo system pigment, diazo system pigment, condensed azo system pigment, metal complex system pigment, quinophthalone system pigment, Indanthrene Blue pigment, dioxadene violet pigment, anthraquinone pigment, metal complex pigment, and benzimidazolone system pigment.

In addition, an azomethine system pigment and/or a perylene system pigment are preferably incorporated as a pigment.

The amount of the pigment is preferably 0.01 to 80 wt %.

In addition, the resin component is preferably a synthetic resin having an absorbance of 10% or less with respect to infrared rays having a wavelength within a range of 800 to 1600 nanometers.

Furthermore, the pigment preferably has an average particle diameter of 0.01 to 30 μm.

The infrared reflector in the first embodiment of the present invention has an infrared-reflecting layer with a reflectance of 60% or more, and a permeability of 25% or less with respect to infrared rays having a wavelength within a range of 800 to 1600 nanometers, and a carbon black amount of 0.1 wt % or less.

The infrared reflector in another embodiment of the present invention has an infrared-reflecting layer and an infrared-permeable layer formed on the infrared-reflecting layer, and this infrared-reflecting layer has a reflectance of 60% or more, and a permeability of 25% or less with respect to infrared rays having a wavelength within a range of 800 to 1600 nanometers, and the infrared-permeable layer has a reflectance of less than 60%, an absorbance of 50% or less, with respect to infrared rays having a wavelength of 800 to 1600 nanometers; the infrared-permeable layer contains resin components and pigments, and the amount of carbon black contained in the infrared-permeable layer is 0.1 wt % or less.

The infrared-reflecting layer may contain, in an amount within a range of 5 to 80 wt %, one or two or more selected from a group containing iron oxide powder, titanium oxide powder, scaly aluminum powder, stainless steel powder, and mica powder covered with titanium oxide, in addition to resin components.

The pigment concentration per unit surface area of the infrared reflector is preferably such that the pigment concentration in the infrared-permeable layer is lower than the pigment concentration in the infrared-reflecting layer.

Furthermore, the percentage of the pigment in each layer per unit of surface area of the infrared reflector is preferably such that the pigment in the infrared-permeable layer is 30 wt % or less and the pigment in the infrared-reflecting layer is 40 wt % or more.

The thickness of the infrared-permeable layer is preferably equal to or less than the thickness of the infrared-reflecting layer

In addition, the infrared-reflecting layer may be a metal, white glass, a white ceramic, or a metallic film formed on the surface of a base material.

The infrared-permeable layer is preferably formed by the above composition for the infrared-permeable layer.

The infrared-reflecting product of the present invention includes the above-described infrared reflector formed thereon.

### BRIEF DESCRIPTION OF THE DRAWINGS

FIG. 1 is a cross-sectional drawing showing the test method for the Example 1 and the Comparative Example 1.

FIG. 2 is a cross-sectional drawing showing the test method for the Example 2 and the Comparative Example 2.

FIG. 3 is a cross-sectional drawing showing the test method for the Example 3 and the Comparative Example 3.

FIG. 4 is a cross-sectional drawing showing the test method for the Example 4 and the Comparative Example 4.

### DETAILED DESCRIPTION OF THE PREFERRED EMBODIMENTS

Below, favorable embodiments of the synthetic resin pallet according to the present invention will be explained with reference to the figures. However, the present invention is not limited by any of the following embodiments, and for example, the essential elements of these embodiments may be suitably combined together.

Composition for Forming Infrared-Permeable Layer

The composition for forming an infrared-permeable layer of the present invention contains a resin component and pigments having an absorbance of 50% or less with respect to infrared rays having a wavelength within a range of 800 to 1600 nanometers and contains 0.1 wt % or less of carbon black. This composition for forming an infrared-permeable layer may be a liquid or powdered paint, or in the shape of a film, or may be the wall materials or panels forming the surfaces of products.

In the present invention, carbon black, which strongly absorbs the infrared rays having a wavelength within a range of 800 to 1600 nanometers, which particularly strongly contribute to the generation of heat among the infrared rays contained in sunlight, is used in small amounts or is not used at all, and thereby, the absorption of infrared rays is suppressed. On the other hand, by employing a pigment which fulfills the conditions described above as the coloring agent, it is possible to produce a variety of colors while suppressing the absorption of the infrared rays. As the amount of carbon black contained decreases, the infrared absorption decreases, and the amount of carbon black contained is preferably 0.05 wt % or less, and more preferably 0 wt %.

It is possible to employ a variety of varnishes (oil varnish and/or spirit varnish), resins for use in paints, common plastics, and engineering plastics as the resin component; however, in any case, it is necessary that there be little absorption of infrared rays. It is preferable that the infrared absorbance of the resin component be 10% or less with respect to infrared rays having a wavelength within a range of 800 to 1600 nanometers.

In the present specification, “infrared absorbance of the resin component” is a numerical value in which a film having a thickness of 20 micrometers is produced using this resin component, and the absorbance with respect to infrared rays having a wavelength within a range of 800 to 1600 nanometers is measured.

Examples of the resin for paints include, for example, alkyd resins, phthalic acid resins, vinyl resins, acrylic resins, fluorine resins, polyamide resins, unsaturated polyester resins, chlorinated polyolefin resins, amino resins, polyurethane resins, silicone resin, acrylic-silicone resins, silicone-acrylic resins, xylene resins, petroleum resins, ketone resins, liquid polybutadiene, rosin-denatured maleic acid resins, coumarone resin, ethyl silicate, resin for powdered paints, resin for ultraviolet ray curing, epoxy resin, olefin resin, phenol resin, and the like. It is also possible to use water-soluble resin. Among these, acrylic resin, polyurethane resin, acrylic-silicone resin, silicone-acrylic resin, fluorine resin, and the like, have little absorption of infrared rays, and have superior dispersion properties in the infrared-permeable pigment, and for these reasons they are preferable.

Furthermore, examples of the general-purpose and engineering plastics include, for example, polyethylene resin, ethylene-vinyl acetate copolymer resin, polypropylene resin, polystyrene resin, AS resin, ABS resin, methacrylic resin, polyvinyl chloride resin, polyamide resin, polycarbonate resin, polyethylene terephthalate resin, polybutylene terephthalate resin, diallylphthalate resin, urea resin, melamine resin, xylene resin, phenol resin, unsaturated polyester resin, epoxy resin, furan resin, polybutadiene resin, polyurethane resin, melamine phenol resin, chlorinated polyethylene resin, vinylidene chloride resin, acrylic-vinyl chloride copolymer resin, AAS resin, ACS resin, polyacetal resin, polymethylpentene resin, polyphenylene oxide resin, denatured PPO resin, polyphenylene sulfide resin, butadiene styrene resin, polyamino bismaleimide resin, polysulfone resin, polybutylene resin, silicone resin, polyethylene tetrafluoride resin, polyethylene fluoride propylene resin, perfluoro alkoxy fluoride plastic, polyvinylidene fluoride resin, MBS resin, methacrylic-styrene resin, polyimide resin, polyallylate resin, polyallylsulfone resin, polyethersulfone resin, polyetheretherketone resin, and the like. Among these, ABS resin, polycarbonate resin, unsaturated polyester resin, polypropylene resin, denatured PPO resin, polyamide resin, and the like, are preferable in that pigments are easily dispersed in them.

Either inorganic pigments or organic pigments may be employed as the pigment contained in the composition for forming an infrared-permeable layer. Inorganic pigments which may be employed include, for example, iron oxide pigments, titanium oxide pigments, composite oxide system pigments, titanium oxide-coated mica pigments, iron oxide-coated mica pigments, scaly aluminum pigments, zinc oxide pigments, and the like.

Examples of the organic pigment which may be employed include, for example, copper phthalocyanine pigment, dissimilar metal (nickel, cobalt, iron, or the like) phthalocyanine pigment, non-metallic phthalocyanine pigment, chlorinated phthalocyanine pigment, chlorinated-brominated phthalocyanine pigment, brominated phthalocyanine pigment, anthraquinone, quinacridone system pigment, diketo-pyrrolipyrrole system pigment, perylene system pigment, monoazo system pigment, diazo system pigment, condensed azo system pigment, metal complex system pigment, quinophthalone system pigment, Indanthrene Blue pigment, dioxadene violet pigment, anthraquinone pigment, metal complex pigment, benzimidazolone system pigment, and the like. Additionally, pigments having little infrared absorption may be employed.

In particular, when a dark color is to be produced, azomethine system organic pigments such as the “A-1103 Black” trademarked product produced by Dainichiseika Color & Chemicals Mfg. Co., Ltd., and perylene system pigments such as the “Perylene Black S-0084” trademarked product produced by BASF Corporation, are optimal as black pigments which substitute for carbon black, and these may be dispersed in the resin component either singly or in combination with other pigments. The amount contained thereof is preferably within a range of 0.01 to 80 wt %, and more preferably within a range of 0.1 to 30 wt %.

When the absorbance of the coloring pigment with respect to infrared rays having a wavelength within a range of 800 to 1600 nanometers is greater than 50%, then the degree of freedom in the color decreases. It is more preferable that the infrared absorbance be 30% or less.

Moreover, as used in the specification, “the infrared absorbance of the pigment” is a numerical value obtained when a pigment is dispersed at 5 wt % in an acrylic resin, which is a resin for painting, a film having a thickness of 20 micrometers is formed, and the absorbance with respect to infrared rays having a wavelength within a range of 800 to 1600 nanometers nm is measured.

The amount of coloring pigment contained is preferably within a range of 5 to 80 wt %, and more preferably an amount within a range of 10 to 30 wt %. When the amount of pigment is large, the infrared light is transmitted through the infrared light permeable layer with difficulty, and the amount of infrared light absorbed by the paint increases, while on the other hand when the amount of pigment is small, coloring becomes difficult.

It is preferable that the average grain diameter of the pigment be within a range of 0.01 to 30 micrometers, and a range of 0.05 to 1 micrometer is more preferable. Within these ranges, it is possible to increase the ultimate infrared reflectance when the reflector described hereinbelow is formed, and the dispersion properties are also good.

When the composition for forming an infrared-permeable layer of the present invention is a paint, in order to simplify the application operation, it may be diluted with appropriate solvents, for example, organic solvents, water, or mixtures of water and organic solvents. Furthermore, where necessary, a dispersing agent or dispersing assistant may be added to the solvent.

Infrared Reflector

The composition for forming an infrared-permeable layer described above is used for the purpose of coating an infrared-reflecting layer having a reflectance of 60% or more with respect to infrared rays having a wavelength within a range of 800 to 1600 nanometers, and forms an infrared-permeable layer as a coloring layer and a protective layer. By means of this infrared reflector having a two-layer structure, the infrared rays which pass through the infrared-permeable layer, which is the coloring layer, are reflected by the infrared-reflecting layer which is beneath, and again pass through the infrared-permeable layer and escape to the exterior, so that it is possible to suppress the rise in temperature of covered structures and the like at a low level. Furthermore, by selecting a pigment from those described above which has a desired color as the pigment for the infrared-permeable layer, it is possible to provide the required color and design. That is to say, an infrared-reflecting function is primarily obtained by the lower layer, while the design characteristics are improved by the upper layer. Additionally, the reflective layer, which is the lower layer, is protected by the upper layer, so that it is possible to cause the infrared-reflecting properties to continue in a stable fashion over a long period of time.

The infrared-reflecting layer described above has a reflectance of 60% or more and a permeability of 25% or less with respect to infrared rays having a wavelength within a range of 800 to 1600 nanometers, and more preferably, the permeability is 10% or less. When the permeability is greater than 25%, the reflectance of the reflector declines. Reflectance, permeability, and absorbance as used herein refer to numerical values obtained by a measurement of all layers; these measurements may be made using the automatic recording spectrophotometer “U-4000” produced by Hitachi Seisakujo, for example. The measurement of the reflection may be conducted under conditions of, for example, 5% mirror reflection.

The infrared-permeable layer described above has a reflectance of less than 60% and an absorbance of 50% or less with respect to infrared rays having a wavelength within a range of 800 to 1600 nanometers. When the absorbance is greater than 50%, the reflectance as a reflector declines. When the permeability is less than 30%, the reflectance as a reflector decreases, and thus preferably the permeability is 30% or more, and more preferably, 50% or more.

It is possible to use a layer formed from a resin composition having as a coloring component thereof an infrared-reflecting pigment having the characteristics of efficiently reflecting infrared rays and efficiently emitting extreme infrared rays as the infrared-reflecting layer. One or two or more selected from a group containing iron oxide pigment, titanium oxide pigment, composite oxide system pigment, titanium oxide-coated mica pigment, iron oxide-coated mica pigment, scaly aluminum pigment, and zinc oxide pigment may be employed as this type of infrared-reflecting pigment. Examples of the organic pigment which may be employed include, for example, copper phthalocyanine pigment, dissimilar metal (nickel, cobalt, iron, or the like) phthalocyanine pigment, non-metallic phthalocyanine pigment, chlorinated phthalocyanine pigment, chlorinated-brominated phthalocyanine pigment, brominated phthalocyanine pigment, anthraquinone, quinacridone system pigment, diketo-pyrrolipyrrole system pigment, perylene system pigment, monoazo system pigment, diazo system pigment, condensed azo system pigment, metal complex system pigment, quinophthalone system pigment, Indanthrene Blue pigment, dioxadene violet pigment, anthraquinone pigment, metal complex pigment, benzimidazolone system pigment, and the like. Additionally, pigments having little infrared absorption may be employed. Among these, titanium oxide is preferable from the point of view of reflective properties and cost. The infrared reflective pigment may contain an azomethine organic pigment such as the “A-1103 Black” trademarked product produced by Dainichiseika Color & Chemicals Mfg. Co., Ltd. or a perylene system pigment such as the “Perylene Black S-0084” trademarked product produced by BASF Corporation.

The amount of pigment contained in the infrared reflective layer is not limited; however, an amount in a range of 5 to 80 wt % is preferable, 10 to 80 wt % is more preferable, and 40 to 80 wt % is most preferable.

The average grain diameter of the pigment in the infrared reflective layer is preferably within a range of 0.01 to 100 micrometers, and more preferably within a range of 0.1 to 25 micrometers. In particular, when titanium oxide is employed, that having a grain diameter within a range of 0.05 to 1 micrometer is preferable from the point of view of the reflective properties.

When titanium oxide is employed in the infrared reflective layer, if scaly aluminum pigment, mica pigment, or the like is added, an even higher reflectance may be obtained. The infrared reflective layer is not limited to one layer; two or more layers may be employed.

The less the amount of carbon black, the less the infrared absorbance, and preferably the amount of carbon black is 0.05 wt %, and more preferably, 0 wt %.

The pigment concentration per unit surface area of the infrared reflector is preferably such that the pigment concentration in the infrared-permeable layer is lower than the pigment concentration in the infrared-reflecting layer. When the pigment concentration in the infrared-permeable layer is higher, the amount of infrared light absorbed in the infrared-permeable layer increases, and the effect of limiting the rise in temperature cannot be improved.

Furthermore, preferably the pigment in the infrared-permeable layer is 30 wt % or less, and the pigment in the infrared-reflecting layer is 40 wt % or more.

In satisfying these conditions, in addition to making the pigments concentration in each of the respective layers fall within the appropriate range, even if the pigment concentration in each of the layers is equal, adjustments can be made by varying the proportions of the layers. For example, even if the pigment concentration in each of the layers is equal, if the thickness of the infrared-permeable layer is half the thickness of the infrared-reflecting layer, the amount of pigment per unit of surface area will be half.

Therefore, not only the difference in concentration, but preferably the thickness of the infrared-permeable layer is equal to or less than the thickness of the infrared-reflecting layer.

Where necessary, extender pigment having infrared reflective properties, such as silica, magnesium silicate, calcium carbonate, or the like, may be added to the infrared reflective layer and the infrared-permeable layer, and the gloss may be adjusted. The amount of extender pigment contained is not limited; however, it is preferable that this be 25 wt % or less of each layer.

The infrared-permeable layer is also not limited to one layer; this may include two or more layers, such as a transparent layer which chiefly carries out a protective function and a design layer containing a concentration of coloring components. Furthermore, the infrared reflective layer may be a molded product including the resins described above, or may be a product in which functional parts or the like are resin-molded.

Furthermore, the infrared reflective layer may be metal, white glass, white ceramic, or one in which a metal film is formed on the surface of a base member. In this case, it is preferable that the surface of the infrared reflective layer be made a mirrored surface. The metal layer described above may be a metal film formed by plating, sputtering, vacuum deposition, ion plating, or the like on the surface of a base member. The material of the base member is not limited; it is possible to use, for example, metal, glass, ceramic, plastic, concrete, wood, or the like.

Moreover, in the case that the required coloring is small, by forming an infrared-reflecting layer without forming an infrared-permeable layer, the limiting of the temperature rise is possible. In this case, the manufacturing processes are simplified, and damage due to the pealing of the paint is difficult to notice.

The infrared-reflecting treated product of the present invention forms the infrared reflector described above on the surface of a treated product such as a wall. The infrared reflector is formed on all or a part of the treated product surface on the infrared-reflecting treated product of the present invention.

By forming the infrared reflector described above, the temperature rise of the treated product

### EXAMPLES

Hereinbelow, the effects will be demonstrated using examples of the present invention. The present invention is not restricted to the structure of the examples given hereinbelow.

### Example 1

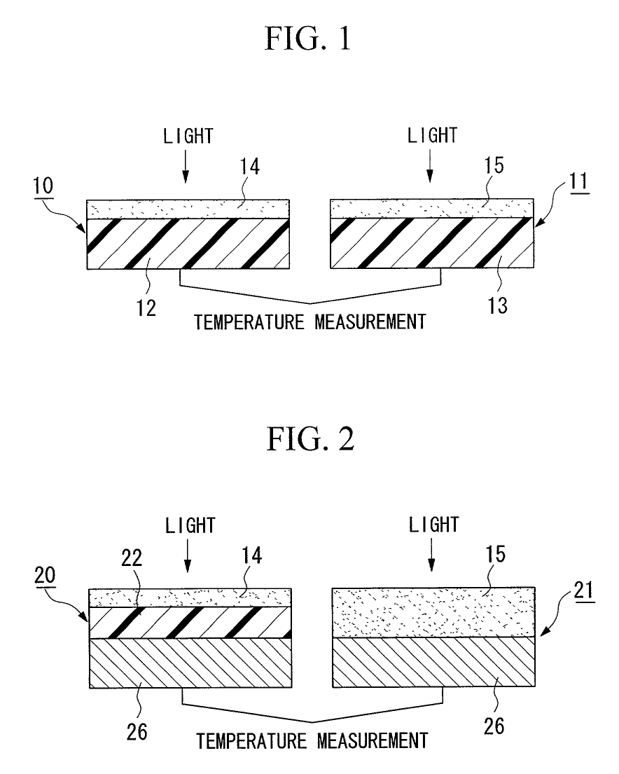

As an infrared layer, ABS resin at 60 wt % and titanium oxide [FR41] (Furukawa Kougyou, average particle diameter 0.2 micrometers; purity, 94%) at 40 wt % were heated and kneaded, molded into a plate having a thickness of 3 mm, and the infrared-reflecting layer, which was a white ABS infrared plate shown in FIG. 1, was formed.

This infrared-reflecting layer had a reflectance of 80% and a permeability of 1% with respect to infrared rays having a wavelength within a range of 800 to 1600 nanometers.

Next, the following raw materials were mixed in advance in a mixer, and after this, were dispersed uniformly in a sand mill, and thereby, a composition (A) for forming an infrared-permeable layer was prepared.

Acrylic varnish (solid component 50%): 68.0 parts by weight

Perylene Black S-0084 (produced by BASF Corporation): 3.0 parts by weight

Shimura First Yellow 4192 (produced by Dainippon Ink and Chemicals, Inc.): 1.0 parts by weight

Chromophthal Red 6820 (produced by Dainichiseika Color & Chemicals Mfg. Co., Ltd.): 0.2 parts by weight

Mixed solution of toluene 5/xylene 10: 27.8 parts by weight

The color of this pigment composition was 5YR2/1.5 when expressed in Munsell notation, and it appeared dark brown. In addition, the absorbance with respect to infrared rays having a wavelength within a range of 800 to 1600 nanometers in the resin component was 1% and that in the pigment was 9%.

The composition (A) for the infrared-permeable layer formation was diluted by a thinner to a sprayable viscosity, spray painting in an air spray gun was carried out on the infrared-reflecting layer 12, this was dried for 10 minutes at room temperature and for 30 minutes at 80° C., and a painted layer having a thickness of approximately 25 micrometers was formed as the infrared-permeable layer, and a brown colored infrared reflector 10 was obtained.

With respect to the wavelength range of 800 to 1600 nm, this infrared-permeable layer had a reflectance of 20%, the absorbance of the resin and pigment was 10%, and the permeability was 70%.

### Example 2

50 parts by weight of an acrylic varnish (with a solid component of 60%), 25 parts by weight of the titanium oxide “FR 41” (produced by Furukawa Kougyou K. K.), and 25 parts by weight of a mixed solution of toluene 10/xylene 15, were mixed and agitated in advance, and were then uniformly dispersed using a sand mill, and thus a paint for forming an infrared reflective layer was prepared.

Next, this paint was diluted using a thinner, and was adjusted to a sprayable viscosity, and spray application was conducted using an air spray gun onto the smoothly polished mirror surface of a iron plate 26 having a thickness of 3 mm, this was dried for 10 minutes at room temperature and for 30 minutes at 80° C., and an infrared reflective layer 22 having an average coating film thickness of 25 micrometers such as that shown in FIG. 2, was prepared.

With respect to infrared rays having a wavelength within a range of 800 to 1600 nanometers, this infrared-reflecting layer has a reflectance of 85 to 80% and a permeability of 0.0%.

The composition (A) for forming an infrared-permeable layer produced in Example 1 was diluted using a thinner to a sprayable viscosity, and spray application was conducted onto the infrared reflective layer 22 using an air spray gun, this was dried for 10 minutes at room temperature and for 30 minutes at 80° C., and an infrared-permeable layer 14 (with an average thickness of 25 micrometers) was formed, and thus a dark brown infrared reflector 2 was obtained.

### Example 3

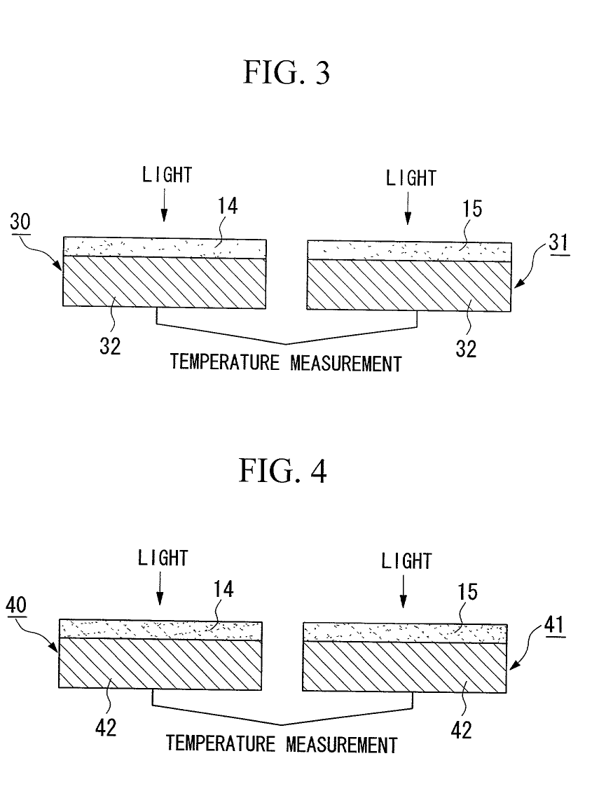

As shown in FIG. 3, an aluminum plate 32 having a thickness of 3 millimeters having a smoothly polished mirrored surface was prepared as the infrared reflective layer.

With respect to infrared rays having a wavelength within a range of 800 to 1600 nanometers, this infrared-reflecting layer has a reflectance of 75 to 80% and a permeability of 0.0%.

The composition (A) for forming an infrared-permeable layer used in Example 1 was diluted using thinner to a sprayable viscosity, and spray application was conducted onto the smoothly polished surface of the aluminum plate 32 using an air spray gun, this was dried for 10 minutes at room temperature and for 30 minutes at 80° C., and an infrared-permeable layer 14 (with an average thickness of 25 micrometers) was formed, and thus a dark brown infrared reflector 30 was obtained.

### Example 4

As shown in FIG. 4, a stainless steel plate 42 having a thickness of 3 millimeters and with a smoothly polished mirrored surface was prepared as the infrared reflective layer.

With respect to infrared rays having a wavelength within a range of 800 to 1600 nanometers, this infrared-reflecting layer has a reflectance of 75 to 80% and a permeability of 0.0%.

The composition (A) for forming an infrared-permeable layer produced in Example 1 was diluted using thinner to a sprayable viscosity, and spray application was conducted onto the smoothly polished surface of the stainless steel plate 42 using an air spray gun, and this was dried for 10 minutes at room temperature, and for 30 minutes at 80° C., and an infrared-permeable layer 14 (with an average thickness of 25 micrometers) was formed, and thus an infrared reflector 40 was obtained.

### Comparative Example 1

The following raw materials were agitated in a mixer, and after this, were uniformly dispersed in a sand mill, and the paint of Comparative Example 1 was prepared.

Acrylic varnish (solid component 50%): 68.0 parts by weight

Carbon black FW200 (produced by Degusa Corporation): 1.0 parts by weight

Shimura First Yellow 4192 (produced by Dainippon Ink and Chemicals Corporation): 2.0 parts by weight

Chromophthal Red 6820 (produced by Dainichiseika Color & Chemicals Mfg. Co., Ltd.): 1.0 parts by weight

Mixed solution of toluene 5/xylene 10: 28.0 parts by weight

The color of this paint composition was the same of the composition (A) of Example 1, and was 5YR2/1.5 when expressed in Munsell notation, and appeared dark brown. With respect to infrared rays having a wavelength within a range of 800 to 1600 nanometers, the absorbance of the resin component was 1% and the pigment component was 94%.

The painting composition was diluted using thinner to a sprayable viscosity, spray application of paint was conducted on a commercially available gray ABS resin plate 13 (reflectance of 70% and permeability of 0.0% with respect to the wavelength range of 800 1600 nm) using an air spray gun, this was dried for 10 minutes at room temperature and for 30 minutes at 80° C., an approximately 25 micrometer paint coating film 15 such as that shown in FIG. 1 was formed, and the dark brown infrared reflector 11 of Comparative Example 1 was formed.

With respect to infrared rays having a wavelength within a range of 800 to 1600 nanometers, this paint coating film has a reflectance of 5%, an absorbance of 95%, and a permeability of 0.0%.

### Comparative Example 2

As shown in FIG. 2, the paint composition of Comparative Example 1 above was diluted using a thinner to a sprayable viscosity, and spray application thereof was conducted using an air spray gun, this was dried for 10 minutes at room temperature and for 30 minutes at 80° C., and a paint coating film 15 having an average thickness of 45 micrometers was formed, and thus a dark brown infrared reflector 21 was prepared. The thickness was equal to the total thickness of the infrared-reflective layer and infrared-permeable layer of the infrared reflector of Example 2.

### Comparative Example 3

The paint composition of Comparative Example 1 was diluted using a thinner to a sprayable viscosity, and spray application thereof was conducted using an air spray gun onto an aluminum plate 32 identical to that of Example 3 such as that shown in FIG. 3, this was dried for 10 minutes at room temperature and for 30 minutes at 80° C., and a coating film 15 having an average thickness of 25 micrometers was formed, and thus a dark brown infrared reflector 31 was prepared. The thickness thereof was equivalent to the thickness of the infrared reflector of Example 3.

### Comparative Example 4

As shown in FIG. 4, the paint composition of the Comparative Example 1 described above was diluted using a thinner to a sprayable viscosity, and the spray application thereof was conducted using an air spray gun onto a stainless steel plate 42 identical to that of Example 4, this was dried for 10 minutes at room temperature and for 30 minutes at 80° C., and a coating film 15 having an average thickness of 25 micrometers was formed, and thus a dark brown infrared reflector 41 was prepared. The thickness thereof was equivalent to the thickness of the infrared reflector of Example 4.

### Experiment 1

The infrared reflectors of Examples 1 through 4 and Comparative Examples 1 through 4 were arranged in the same horizontal plane within a box made of white foam styrene with a thickness of 20 millimeters, the box having dimensions of 250 millimeters length by 360 millimeters width by 60 millimeters height, and the box was covered with a transparent glass plate having a thickness of 3 millimeters so as to eliminate wind effects, and was placed in sunshine outdoors, and the temperature on the rear surface of each infrared reflector was measured.

Table 1 shows the temperatures immediately before the application of sunlight, and at 15 minutes, 30 minutes, 45 minutes, 60 minutes, and 75 minutes thereafter.

TABLE 1

| Elapsed | Example 1 | Comparative | Example 2 | Comparative | Example 3 | Comparative | Example 4 | Comparative |
|---|---|---|---|---|---|---|---|---|
| Time (min) | (° C.) | Example 1 (° C.) | (° C.) | Example 2 (° C.) | (° C.) | Example 3 (° C.) | (° C.) | Example 4 (° C.) |
| 0 | — | — | 15 | 15 | 15 | 15 | 15 | 15 |
| 15 | 25 | 31 | 65 | 80 | 67 | 79 | 67 | 76 |
| 30 | 42 | 54 | 77 | 93 | 78 | 94 | 77 | 93 |
| 45 | 52 | 65 | 80 | 94 | 80 | 93 | 79 | 95 |
| 60 | 53 | 65 | 79 | 96 | 79 | 96 | 80 | 95 |
| 75 | 60 | 74 | 79 | 97 | 80 | 95 | 80 | 96 |

As can be seen from the experiments, in the interval from 45 to 60 minutes after the application of sunlight, the rise in temperature of the Comparative Examples was larger than that of the Examples, and reached a maximum difference in temperature of 16° C. In these experiments, natural sunlight was applied, so that during periods of cloudiness during the experiment, the temperature decreased slightly.

### Example 5

The following raw materials were mixed in advance in a mixer, and after this, were dispersed uniformly in a sand mill, and thereby, an infrared-permeable reflecting coating was prepared.

Acrylic varnish (solid component 60%): 50.0 parts by weight

Titanium oxide [FR41] (Furukawa Kougyou, average particle diameter 0.2 micrometers; purity, 94%) at 25.0 wt %

Mixed solution of toluene 5/xylene 15: 25.0 parts by weight

This infrared-reflecting layer coating was diluted by a thinner to a sprayable viscosity, spray painting in an air spray gun was carried out on an aluminum plate, this was dried for 10 minutes at room temperature and for 30 minutes at 80° C., and the infrared-reflecting layer having a thickness of 25 micrometers on average is formed.

This infrared-reflecting layer has a reflectance of 85% and a permeability of 0.0% with respect to infrared rays having a wavelength within a range of 800 to 1600 nanometers.

Next, the following raw materials were mixed in advance in a mixer, and after this, were dispersed uniformly in a sand mill, and thereby, a composition for forming an infrared-permeable layer was prepared.

Acrylic varnish (solid component 60%): 50.0 parts by weight

Perylene Black S-0084 (produced by BASF Corporation): 6.0 parts by weight

Biferox 120M (produced by Bayer Corporation): 2.0 parts by weight

Talox HY 250 (produced by Titanium Kougyou): 2 parts by weight

Mixed solution of toluene 5/xylene 10: 40 parts by weight

In this composition for the infrared-permeable layer formation, the absorbance with respect to infrared rays having a wavelength within a range of 800 to 1600 nanometers of the resin component is 1% and the pigment is 14%.

The composition for the infrared-permeable layer formation is diluted by a thinner to a sprayable viscosity, spray painting in an air spray gun is carried out on the infrared-reflecting layer, this was dried for 10 minutes at room temperature and for 30 minutes at 80° C., and an infrared-permeable layer having a coating thickness of 20 micrometers on average is formed, and the infrared reflector was manufactured.

With respect to infrared rays having a wavelength within a range of 800 to 1600 nanometers, this infrared-permeable layer has a reflectance of 20%, the absorbance of 20%, and a permeability of 60%.

### Example 6

Like Example 5, the coating for the infrared-reflecting layer is diluted by a thinner to a sprayable viscosity, spray painting in an air spray gun is carried out on a aluminum plate, this was dried for 10 minutes at room temperature and for 30 minutes at 80° C., and a coating thickness of 25 micrometers on average is formed.

Next, the following raw materials were mixed in advance in a mixer, and after this, were dispersed uniformly in a sand mill, and thereby, a composition for forming an infrared-permeable layer was prepared.

Acrylic varnish (solid component 60%): 50.0 parts by weight

Perylene Black S-0084 (produced by BASF Corporation): 3.0 parts by weight

Biferox 120M (produced by Bayer Corporation): 1.0 parts by weight

Talox HY 250 (produced by Titanium Kougyou): 1 parts by weight

Mixed solution of toluene 5/xylene 15: 45 parts by weight

In this composition for the infrared-permeable layer formation, the absorbance with respect to infrared rays having a wavelength within a range of 800 to 1600 nanometers of the resin component was 1% and that of the pigment was 9%.

The composition for the infrared-permeable layer formation was diluted by a thinner to a sprayable viscosity, spray painting in an air spray gun was carried out on the infrared-reflecting layer, this was dried for 10 minutes at room temperature and for 30 minutes at 80° C., and an infrared-permeable layer having a coating thickness of 20 micrometers on average is formed, and the infrared reflector was manufactured.

With respect to infrared rays having a wavelength within a range of 800 to 1600 nanometers, this infrared-permeable layer had a reflectance of 20%, the absorbance of 10%, and a permeability of 70%.

### Example 7

Like Example 5, the coating for the infrared-reflecting layer was diluted by a thinner to a sprayable viscosity, spray painting in an air spray gun was carried out on a aluminum plate, this was dried for 10 minutes at room temperature and for 30 minutes at 80° C., and a coating thickness of 25 micrometers on average was formed.

Next, the following raw materials were mixed in advance in a mixer, and after this, were dispersed uniformly in a sand mill, and thereby, a composition for forming an infrared-permeable layer was prepared.

Acrylic varnish (solid component 60%): 50.0 parts by weight

Perylene Black S-0084 (produced by BASF Corporation): 1.5 parts by weight

Biferox 120M (produced by Bayer Corporation): 0.5 parts by weight

Talox HY 250 (produced by Titanium Kougyou): 0.5 parts by weight

Mixed solution of toluene 5/xylene 15: 47.5 parts by weight

In this composition for the infrared-permeable layer formation, the absorbance with respect to infrared rays having a wavelength within a range of 800 to 1600 nanometers of the resin component was 1% and that of the pigment was 4%.

The composition for the infrared-permeable layer formation was diluted by a thinner to a sprayable viscosity, spray painting in an air spray gun was carried out on the infrared-reflecting layer, this was dried for 10 minutes at room temperature and for 30 minutes at 80° C., and an infrared-permeable layer having a coating thickness of 20 micrometers on average was formed, and the infrared reflector was manufactured.

With respect to the wavelength range of 800 to 1600 nm, this infrared-permeable layer had a reflectance of 15%, an absorbance of 5%, and a permeability of 80%.

### Comparative Example 5

The following raw materials were mixed in advance in a mixer, and after this, were dispersed uniformly in a sand mill, and thereby, an infrared-permeable reflecting coating was prepared.

Acrylic varnish (solid component 60%): 50.0 parts by weight

Titanium oxide [FR41] (Furukawa Kougyou, average particle diameter 0.2 micrometers; purity 94%) at 5.0 parts by weight

Mixed solution of toluene 5/xylene 15: 45.0 parts by weight

This infrared-permeable layer coating was diluted by a thinner to a sprayable viscosity, spray painting in an air spray gun was carried out on a 3 mm aluminum plate, this was dried for 10 minutes at room temperature and for 30 minutes at 80° C., and the infrared-reflecting layer having a thickness of 25 micrometers on average is formed.

This infrared-reflecting layer has a reflectance of 85% and a permeability of 0.0% with respect to infrared rays having a wavelength within a range of 800 to 1600 nanometers.

Next, like Example 5, the composition for the infrared-permeable layer coating formation was diluted by a thinner to a sprayable viscosity, spray painting in an air spray gun was carried out, this was dried for 10 minutes at room temperature and for 30 minutes at 80° C., the infrared-permeable layer having a thickness of 25 micrometers on average was formed, and the infrared reflector was produced.

The contents of each layer of the Examples 5 to 7 and the Comparative Example 5 are shown in Table 2. In addition, the color of each of the infrared reflectors was 5YR2/1.5

TABLE 2

| | | | | | Comparative Example 5 | |
|---|---|---|---|---|---|---|
| | | Infrared-permeable layer | | | | Infrared- |
| | Infrared-reflecting | Example | Example | Example | Infrared-reflecting | permeable |
| | layer | 5 | 6 | 7 | layer | layer |
| Resin component (wt %) | 30.0 | 30.0 | 30.0 | 30.0 | 30.0 | 30.0 |
| Coloring pigment amount | 25.0 | 10.0 | 5.0 | 2.5 | 5.0 | 10.0 |
| (wt %) | | | | | | |
| Solvent amount (wt %) | 45.0 | 60.0 | 65.0 | 67.5 | 65.0 | 60.0 |
| Coloring pigment ratio (wt %) | 45.5 | 25.0 | 14.3 | 6.3 | 14.3 | 25.0 |
| Coating thickness (μm) | 25 | 20 | 20 | 20 | 25 | 20 |

### Experiment 2

The infrared reflectors of Examples 5 through 7 and Comparative Examples 5 were arranged in the same horizontal plane within a box made of white foam styrene, the box having dimensions of 250 millimeters length by 500 millimeters width by 50 millimeters height, they were irradiated by an infrared lamp (Kett Science Company, 100 V, 185 W) placed 200 mm above them, and the temperature on the rear surface of each infrared reflector was measured.

Table 3 shows the temperatures immediately before the application of sunlight, and at 5 minutes, 10 minutes, 15 minutes, and 20 minutes thereafter.

TABLE 3

| Elapsed Time | Example 5 | Example 6 | Example 7 | Comparative |
|---|---|---|---|---|
| (min) | (° C.) | (° C.) | (° C.) | Example 5 (° C.) |
| 0 | 24 | | | |
| 5 | 70 | 51 | 48 | 76 |
| 10 | 76 | 62 | 59 | 84 |
| 15 | 79 | 67 | 63 | 87 |
| 20 | 81 | 69 | 66 | 89 |

As can be understood form this Experiment, it can be understood that with regards to the coloring pigment ratio, the temperature rise of the infrared reflector in Example 5, in which the infrared-permeable layer is smaller than the infrared-reflecting layer, was limited particularly after 5 to 10 minutes after the irradiation in comparison to Comparative Example 5, in which the infrared-permeable layer was smaller than the infrared-reflecting layer.

In addition, as shown in the results of Examples 5 to 7, much infrared light permeates those having little coloring pigment in the infrared-permeable layer, and thereby rise in the temperature can be reduced.

### Example 8

The following raw materials were mixed in advance in a mixer, and after this, were dispersed uniformly in a sand mill, and thereby, a composition for forming an infrared-reflecting layer was prepared.

Acrylic varnish (solid component 50%): 60.0 parts by weight

Titanium oxide [FR41] (Furukawa Kougyou, average particle diameter 0.2 micrometers; purity 94%) at 20.0 parts by weight

Perylene Black S-0084 (produced by BASF Corporation): 1.0 parts by weight

Shimura First Yellow 4192 (produced by Dainippon Ink and Chemicals, Inc.): 1.0 parts by weight

Chromophthal Red 6820 (produced by Dainichiseika Color & Chemicals Mfg. Co., Ltd.): 0.2 parts by weight

Mixed solution of toluene 5/xylene 10: 17.8 parts by weight

The coating for the infrared-reflecting layer prepared as described above was diluted by a thinner to a sprayable viscosity, spray painting in an air spray gun was carried out on a commercially available 1 mm ABS black plate, this was dried for 10 minutes at room temperature and for 30 minutes at 80° C., and an infrared-permeable layer having a coating thickness of 20 micrometers on average is formed, and the infrared reflector was manufactured.

With respect to infrared rays having a wavelength within a range of 800 to 1600 nanometers, this infrared-permeable layer had a reflectance of 70%, and a permeability of 10%.

### Example 9

The composition (A) for the infrared-permeable layer formation prepared as described above was diluted by a thinner to a sprayable viscosity, spray painting in an air spray gun was carried out on the infrared-reflecting layer of the infrared reflector prepared in Example 8 described above, this was dried for 10 minutes at room temperature and for 30 minutes at 80° C., and an infrared-permeable layer having a coating thickness of 20 micrometers on average is formed, and the infrared reflector was manufactured.

### Comparative Example 6

The following composition was mixed in advance in a mixer, and after this, was dispersed uniformly in a sand mill, and thereby, a paint coating was prepared.

Acrylic varnish (solid component 50%): 60.0 parts by weight

Titanium oxide [FR41] (Furukawa Kougyou, average particle diameter 0.2 micrometers; purity 94%) at 20.0 parts by weight

Carbon black FW200 (produced by Degusa Corporation): 0.2 parts by weight

Shimura First Yellow 4192 (produced by Dainippon Ink and Chemicals Corporation): 1.0 parts by weight

Chromophthal Red 6820 (produced by Dainichiseika Color & Chemicals Mfg. Co., Ltd.): 0.2 parts by weight

Mixed solution of toluene 5/xylene 10: 18.6 parts by weight

The paint coating was diluted by a thinner to a sprayable viscosity, spray painting in an air spray gun was carried out on the a commercially available 1 mm ABS black plate, this was dried for 10 minutes at room temperature and for 30 minutes at 80° C., and an infrared-permeable layer having a coating thickness of 20 micrometers on average was formed, and a painting coating having a 20 micrometer thickness on average was formed.

With respect to infrared rays having a wavelength within a range of 800 to 1600 nanometers, this infrared-permeable layer has a reflectance of 25%, and a permeability of 20%.

### Comparative Example 7

Other than changing the thickness of the paint coating in the Comparative Example 6 described above from 20 micrometers to 40 micrometers, the infrared reflector identical to that in Comparative Example 6 was manufactured.

### Experiment 3

The infrared reflectors of Examples 8 and 9 and Comparative Examples 6 and 7 were arranged in the same horizontal plane, they were irradiated by an fluorescent lamp (Kett Science Company, 100 V, 185 W) placed 200 mm above them, and the temperature on the rear surface of each infrared reflector was measured.

Table 4 shows the temperatures immediately before the application of sunlight, and at 2 minutes, 4 minutes, 6 minutes, and 8, and 10 minutes thereafter.

TABLE 4

| | | Comp. | | Comp. |
|---|---|---|---|---|
| Elaspsed Time | Example 8 | Example 6 | Example 9 | Example 7 |
| (min) | (° C.) | (° C.) | (° C.) | (° C.) |
| 0 | 25 | | | |
| 2 | 56 | 72 | 60 | 67 |
| 4 | 67 | 88 | — | 80 |
| 6 | 74 | 93 | 76 | 84 |
| 8 | 80 | 99 | 80 | 87 |
| 10 | 84 | 103 | 81 | 90 |

As can be understood from Table 4, the rise in the temperature was more limited in the infrared reflectors in the Examples than in the Comparative Examples.

In addition, the rise in the temperature is more limited in the infrared reflector of Example 9 that forms the infrared-permeable layer than in the infrared reflector of Example 8.

### POSSIBILITY OF INDUSTRIAL APPLICATION

The infrared reflector of the present invention limits the rise in temperature due to infrared light while supporting high coloration and the creation of designs.

In particular, by providing a covered layer on the infrared-reflecting layer having a high infrared reflectivity by using the composition for infrared-permeable layer formation, while maintaining the high infrared reflectivity on the whole, various coloration that includes dark colors can be realized.

Therefore, in the infrared-reflecting product according to the present invention, the rise in the temperature due to sunlight is small, and can contribute to the avoidance of operational abnormality of high precision apparatuses.

1. A composition for infrared-permeable layer formation including a resin component and a pigment having an absorbance of 50% or less with respect to infrared rays having a wavelength within a range of 800 to 1600 nanometers.

2. A composition for infrared permeation layer formation according to claim 1, wherein said pigment is one or two or more selected from a group consisting of iron oxide pigment, titanium oxide pigment, composite oxide system pigment, titanium oxide-coated mica pigment, iron oxide-coated mica pigment, scaly aluminum pigment, zinc oxide pigment, metallic phthalocyanine pigment, non-metallic phthalocyanine pigment, chlorinated phthalocyanine pigment, chlorinated-brominated phthalocyanine pigment, brominated phthalocyanine pigment, anthraquinone system pigment, quinacridone system pigment, diketo-pyrrolipyrrole system pigment, perylene system pigment, monoazo system pigment, diazo system pigment, condensed azo system pigment, metal complex system pigment, quinophthalone system pigment, Indanthrene Blue pigment, dioxadene violet pigment, anthraquinone pigment, metal complex pigment, and benzimidazolone system pigment.

3. A composition for infrared permeation layer formation according to claim 1, wherein said pigment includes an azomethine system pigment and/or a perylene system pigment.

4. A composition for infrared permeation layer formation according to claim 1, wherein the amount of said pigment is 0.01 to 80 wt %.

5. A composition for infrared permeation layer formation according to claim 1, wherein said resin component is a synthetic resin having an absorbance of 10% or less with respect to infrared rays having a wavelength within a range of 800 to 1600 nanometers.

6. A composition for infrared permeation layer formation according to claim 1, wherein the average particle size of said pigment is 0.01 to 30 μm.

7. A infrared reflector having a infrared-reflecting layer having a reflectance of 60% or more, a permeability of 25% or less with respect to infrared rays having a wavelength within a range of 800 to 1600 nanometers, and a carbon black amount of 0.1 wt % or less.

8. A infrared reflector having an infrared-reflecting layer and an infrared-permeable layer which is formed on said infrared-reflecting layer, said infrared-reflecting layer having a reflectance of 60% or more and a permeability of 25% or less with respect to infrared rays having a wavelength within a range of 800 to 1600 nanometers, and said infrared-permeable layer having a reflectance of less than 60%, and an absorbance of 50% or less with respect to infrared rays having a wavelength within a range of 800 to 1600 nanometers, said infrared-permeable layer containing resin components and pigments, and an amount of carbon black contained in said infrared-permeable layer being 0.1 wt % or less.

9. An infrared reflector in accordance with claim 7 or 8, wherein said infrared-reflecting layer contains a resin component and one or two or more pigments selected from a group containing iron oxide powder, titanium oxide powder, scaly aluminum powder, stainless steel powder, and mica powder covered with titanium oxide, and an amount of said pigments contained is within a range of 5 to 80 wt %.

10. An infrared reflector in accordance with claim 8, wherein, concerning the pigment concentration per unit of surface area of the infrared reflector, the pigment concentration in the infrared-permeable layer is lower than the pigment concentration in the infrared-reflecting layer.

11. An infrared reflector in accordance with claim 8, wherein the ratio of each layer of the pigment per unit of surface area of the infrared reflector is such that the pigment in the infrared-permeable layer is 30 wt % or less and the pigment in the infrared-reflecting layer is 40 wt % or more.

12. An infrared reflector in accordance with claim 8, wherein the thickness of said infrared-permeable layer is equal to or less than the thickness of the infrared-reflecting layer.

13. An infrared reflector in accordance with claim 8, wherein said infrared reflective layer is one of a metal, a white glass, a white ceramic, or a metal film formed on a surface of a base member.

14. An infrared reflector in accordance with claim 8, wherein said infrared-permeable layer is formed with the compound for infrared-permeable layer formation according to claim 1.

15. An infrared reflecting product having a surface on which the infrared reflector of claim 7 or 8 is formed.
